(19) United States
(12) Patent Application Publication
(10) Pub. No.: US 2020/0249618 A1
(43) Pub. Date: Aug. 6, 2020

(54) IMAGE FORMING DEVICE

(71) Applicant: Konica Minolta, Inc., Tokyo (JP)

(72) Inventor: Motoki Nakano, Toyokawa-shi (JP)

(21) Appl. No.: 16/727,082

(22) Filed: Dec. 26, 2019

(30) Foreign Application Priority Data
Feb. 5, 2019 (JP) 2019-018975

(51) Int. Cl. G03G 21/00

(52) U.S. Cl. CPC G03G 21/0035

(57) ABSTRACT

An image forming device includes: a photoreceptor that forms a toner image; a brush that abuts the photoreceptor to clean a surface of the photoreceptor; an operator that changes a toner residual amount in the brush; and a hardware processor that performs in-brush toner amount control to allow the operator to operate such that the residual amount approaches a set value when a toner image for printing according to a print job is not formed on the photoreceptor as the toner image.

The entire disclosure of Japanese patent Application No. 2019-018975, filed on Feb. 5, 2019, is incorporated herein by reference in its entirety.

### BACKGROUND

### Technological Field

The present invention relates to an image forming device which forms an image using toner.

### Description of the Related Art

An image forming device which forms an image on a sheet by electrophotography forms a toner image on a surface (outer peripheral surface) of a photoreceptor, and transfers the toner image from the photoreceptor to the sheet via an intermediate transfer member or directly. The image forming device cleans the surface of the photoreceptor after the toner image is transferred in preparation for next image formation.

A roll brush is used for cleaning the surface of the photoreceptor. The roll brush is formed of a metallic core and resin brush bristles supported thereby. The roll brush rotates in a state in which the brush bristles abut the photoreceptor and scrapes off toner remained without being transferred and other adhering matter from the photoreceptor. The roll brush provides an effect of leveling adhesion of an external additive away from the toner and an effect of refreshing the surface by shaving a surface layer of the photoreceptor.

As a conventional art regarding control of rotation of the roll brush, there is a technology disclosed in JP 2001-109350 A. JP 2001-109350 A discloses further rotating a fur brush roller in a direction opposite to that at the time of image forming operation after finishing the image forming operation to stop rotation of the photoreceptor drum for a predetermined time, thereby removing the toner remaining in an abutment portion between the photoreceptor drum and the fur brush roller.

The toner scraped off from the photoreceptor adheres to the roll brush. Some toner naturally separates from the roll brush after adhering the roll brush, and some toner remains adhering to the roll brush. Although toner residue may be reduced by providing a flicker for removing the toner from the roll brush, it is difficult to totally eliminate the toner residue. In general, as the roll brush is used, an amount of toner remaining on the roll brush gradually increases.

As the amount of toner remaining on the roll brush increases, brush bristles become harder. This is because each fiber of the brush bristles is coated with thicker toner. When the brush bristles are hardened, a frictional force of the roll brush with respect to the photoreceptor increases, and a depletion amount of a film thickness per unit rotation number of the photoreceptor increases. When the depletion amount exceeds an amount necessary for refreshing the photoreceptor, a life of the photoreceptor becomes shorter than an originally assumed value.

When the roll brush is rotated every time image formation is finished as in the technology of JP 2001-109350 A described above, the image quality might be deteriorated.

### SUMMARY

The present invention is achieved in view of the above-described problem, and an object thereof is to suppress shortening of the life of the photoreceptor and deterioration in image quality due to the residual toner in the brush for cleaning the photoreceptor.

To achieve the abovementioned object, according to an aspect of the present invention, an image forming device reflecting one aspect of the present invention comprises: a photoreceptor that forms a toner image; a brush that abuts the photoreceptor to clean a surface of the photoreceptor; an operator that changes a toner residual amount in the brush; and a hardware processor that performs in-brush toner amount control to allow the operator to operate such that the residual amount approaches a set value when a toner image for printing according to a print job is not formed on the photoreceptor as the toner image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating an outline of a configuration of an image forming device according to an embodiment of the present invention;

FIG. 2 is a view illustrating a configuration of a photoreceptor drum unit;

FIG. 3 is a view illustrating a relationship between a frictional force of a cleaning brush and an a value;

FIG. 4 is a view illustrating a relationship between a toner residual amount and the frictional force in the cleaning brush;

FIG. 5 is a view illustrating a functional configuration of a substantial part of the image forming device;

FIGS. 6A to 6C are views schematically illustrating states of a photoreceptor and the cleaning brush at the time of image formation and in-brush toner amount control;

FIG. 7 is a view illustrating a variation of a configuration of a photoreceptor drum unit;

FIG. 8 is a view illustrating a functional configuration of a substantial part of an image forming device;

FIGS. 9A and 9B are views schematically illustrating states of a photoreceptor, a cleaning brush, and a flicker at the time of image formation and in-brush toner amount control; and

FIG. 10 is a view illustrating a functional configuration of a substantial part of the image forming device.

### DETAILED DESCRIPTION OF EMBODIMENTS

Hereinafter, one or more embodiments of the present invention will be described with reference to the drawings. However, the scope of the invention is not limited to the disclosed embodiments.

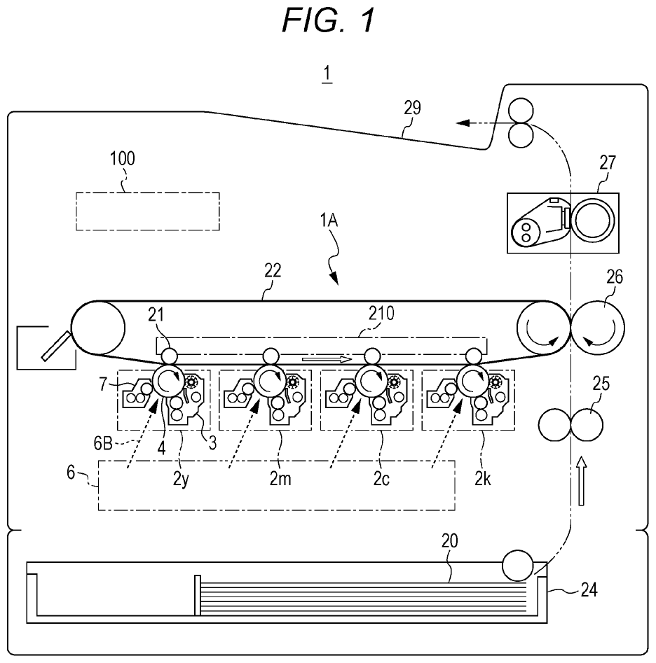

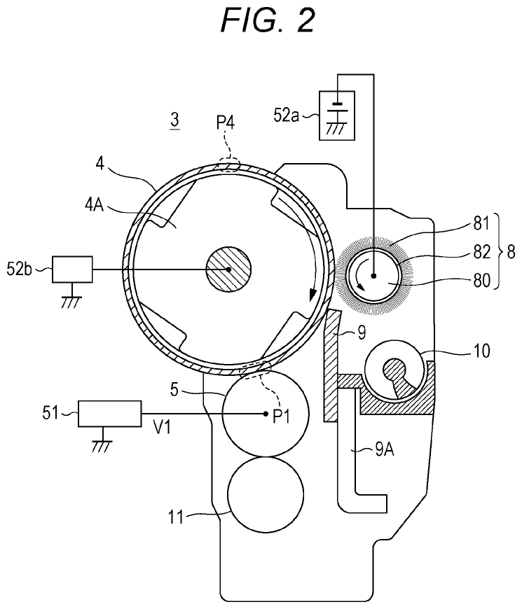

FIG. 1 is a view illustrating an outline of a configuration of an image forming device 1 according to an embodiment of the present invention. FIG. 2 is a view illustrating a configuration of a photoreceptor drum unit 3.

The image forming device 1 illustrated in FIG. 1 is an electrophotographic color printer provided with a tandem printer engine 1A. The image forming device 1 forms a color or monochrome image according to a print job input from an external host device.

The image forming device 1 includes a control circuit 100 which controls operation thereof. The control circuit 100 includes a central processing unit (CPU), a random access memory (RAM), a read only memory (ROM), and a circuit which performs a specific process.

The printer engine 1A includes four imaging stations 2y, 2m, 2c, and 2k, a print head 6, and an intermediate transfer belt 22.

Each of the imaging stations 2y to 2k includes the photoreceptor drum unit 3, a developer 7 and the like. The photoreceptor drum unit 3 includes a cylindrical photoreceptor 4 for forming a toner image. The imaging stations 2y to 2k have basically similar configurations. Hereinafter, the imaging stations 2y to 2k are sometimes referred to as the “imaging station 2” without distinction.

The print head 6 emits a laser beam 6B for performing pattern exposure (latent image formation) to each of the imaging stations 2y to 2k. Main scanning to deflect the laser beam 6B in a rotation axis direction of the photoreceptor 4 is performed in the print head 6. In parallel to this main scanning, sub scanning is performed to rotate the photoreceptor 4 at a constant speed.

The intermediate transfer belt 22 is a transferred member in primary transfer of a toner image. The intermediate transfer belt 22 is wound around a pair of rollers to rotate. Inside the intermediate transfer belt 22, four primary transfer rollers 21 for applying a transfer voltage to the photoreceptors 4 of the imaging stations 2 and a pressure contact/separation mechanism 210 are arranged. The pressure contact/separation mechanism 210 moves the four primary transfer rollers 21 collectively or selectively in a radial direction of the photoreceptor 4 to bring/allow the photoreceptor 4 into pressure contact with/to separate from the intermediate transfer belt 22.

In a color printing mode, the imaging stations 2y to 2k form toner images of four colors of yellow (Y), magenta (M), cyan (C), and black (K) in parallel by performing charging, pattern exposure, and development. The toner images of four colors are sequentially primarily transferred to the intermediate transfer belt 22 which is rotating First, the toner image of Y is transferred, and the toner images of M, C, and K are sequentially transferred so as to overlap with the same.

In a monochrome printing mode, the toner image of K is formed by the imaging station 2k out of the four imaging stations 2y to 2k. The other imaging stations 2y to 2c do not form the toner images.

When the primarily transferred toner image is opposed to a secondary transfer roller 26, this is secondarily transferred to a sheet (recording medium) 20 taken out from a paper feed cassette 24 on a lower side and conveyed through a timing roller 25. Then, the sheet 20 is delivered to a paper ejection tray 29 on an upper side through an inside of a fixing unit 27. When passing through the fixing unit 27, the toner image is fixed to the sheet 20 by heating and pressurization.

Toner used to form the toner image in the image forming device 1 is obtained by allowing a lubricant to adhere as an external additive to a surface of a binder resin particle to which a coloring material, a charge adjusting agent, a mold release agent and the like are added. The lubricant is a solid substance which makes it difficult for a discharge product in charging to adhere to the photoreceptor 4 or reduces friction between a cleaning blade 9 to be described later and the photoreceptor 4. For example, zinc stearate being a type of fatty acid metal salt is preferable as the lubricant.

As illustrated in FIG. 2, the photoreceptor drum unit 3 includes the photoreceptor 4, a charging roller 5, a cleaning brush 8, a cleaning blade 9, a conveying screw 10, a cleaning roller 11 and the like.

The photoreceptor 4 is an organic photoreceptor in which an underlayer, a charge generation layer containing organic molecules, a charge transportation layer, and a protective layer are laminated on a conductive substrate. The photoreceptor 4 is supported by a conductive drum 4A and is rotary driven clockwise in the drawing.

A potential of the drum 4A is switched by a potential switching unit 52b to a ground potential (0 volt) or a potential having a polarity (for example, positive) opposite to that of a charging potential of the toner (for example, negative).

The charging roller 5 is a charging member of a system of charging a surface of the photoreceptor 4 (contact charging system or proximity charging system) by bringing/approximating the charging member into contact with/to the photoreceptor 4, the member formed of a metallic core and a roll-shaped semiconductor rubber layer supported thereby. The charging roller 5 abuts the photoreceptor 4 in a charging position P1 and rotates following the photoreceptor 4. The charging position P1 includes a nip portion between the charging roller 5 and the photoreceptor 4 and the vicinity of the nip portion.

A charging bias V1 is applied to the charging roller 5 by a high-voltage power supply circuit 51 at the time of image formation (printing operation). The charging bias V1 is a high-frequency voltage obtained by superimposing an AC voltage with a DC voltage. However, the charging bias V1 may also be a DC voltage.

The cleaning roller 11 is a cleaning member which cleans the charging roller 5. The cleaning roller 11 removes a foreign matter generated by the discharge between the photoreceptor 4 and the charging roller 5 to adhere to the charging roller 5 while abutting the charging roller 5 to rotate.

The cleaning brush 8 and the cleaning blade 9 are cleaning members which clean the photoreceptor 4. An area on the surface of the photoreceptor 4 which passes through a primary transfer position P4 and moves toward the charging position P1 is cleaned by the cleaning brush 8 and the cleaning blade 9. In this embodiment, the cleaning brush 8 is arranged on an upstream side of the cleaning blade 9 in a rotational direction of the photoreceptor 4.

The cleaning brush 8 is a roll brush formed of a metallic core 80 and brush bristles 81 provided on a peripheral surface thereof. The brush bristles 81 are shaped into a roll shape by a manufacturing method in which an elongated base fabric 82 in which a fiber bundle is woven as a pile yarn is wound around the metallic core 80 in a spiral manner to be bonded. A diameter of the cleaning brush 8 is, for example, 11.3 mm, and a length of a portion with the brush bristles 81 in a rotation axis direction is, for example, 310 mm.

The cleaning brush 8 is arranged so that the brush bristles 81 are pressed against the photoreceptor 4 to be bent in a biting state, and is rotary driven so as to cause a difference in peripheral speed with the photoreceptor 4.

A rotational direction of the cleaning brush 8 is a direction (so-called “with direction”) in which a moving direction of a peripheral edge is the same as that of the photoreceptor 4 at an abutment portion with the photoreceptor 4.

Nylon, polyester, acryl, vinylon, or other chemical fibers are used as fibers of the brush bristles 81. It is possible to impart conductivity to each fiber of the brush bristles 81 by dispersing a conductive material such as carbon or nickel in the fiber or coating the surface of the fiber with the same.

Values of parameters such as the Young's modulus, fineness, implantation density, and bristle length of the fibers of the brush bristles 81, a biting amount of the brush bristles 81 into the photoreceptor 4, and a peripheral speed difference with the photoreceptor 4 are selected such that a frictional force F against the photoreceptor 4 determined by a combination of them has a desired magnitude. Note that, the frictional force F may be measured using a commercially available micro force type pressing force sensor capable of detecting in mN order.

The value of Young's modulus is preferably in a range of 1,500 to 9,800 [N/mm²], the value of fineness is preferably in a range of 3 to 15 [denier], and the value of the implantation density is preferably in a range of 30,000 to 500,000 [inch²]. In a case where outer dimensions of the brush bristles 81 are set to the above-described values, the value of bristle length is preferably in a range of about 1 to 3.5 [mm], and the biting amount value is preferably in a range of 0.5 to 1.5 [mm]. The value of peripheral speed difference may be set to a value of about 1 to 2 [mm/s], for example.

The metallic core 80 of the cleaning brush 8 is biased to a potential having the same polarity as that of the charging potential of the toner by a brush potential setting unit 52a.

The cleaning blade 9 is a plate-shaped elastic material (for example, urethane rubber), and is fixed to a stay 9A so that an edge on a free end side thereof abuts the photoreceptor 4 in a cantilevered form. An arrangement system of the cleaning blade 9 is a counter system (doctor system) in which a tip end surface is directed to an upstream side in the rotational direction of the photoreceptor 4.

The cleaning blade 9 abuts the photoreceptor 4 in an elastically deformed state, and comes into pressure contact with the photoreceptor 4 by its restoring force. The cleaning blade 9 removes the toner which could not be removed by the cleaning brush 8 from the photoreceptor 4.

A conveying screw 10 conveys a foreign matter such as the toner removed by the cleaning brush 8 and the cleaning blade 9 from the photoreceptor 4 to a waste toner box. The conveying screw 10 is rotary driven to generate an air flow which flows from the photoreceptor drum unit 3 to the waste toner box. The foreign matter is sent to the waste toner box by this air flow.

The image forming device 1 has a function of reducing a change over time in which the brush bristles 81 of the cleaning brush 8 gradually become hard. Hereinafter, a configuration and operation of the image forming device 1 are described focusing on this function.

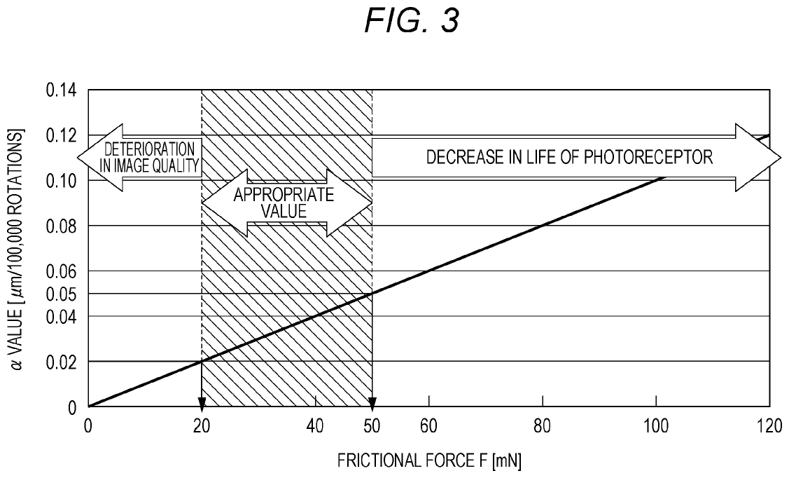

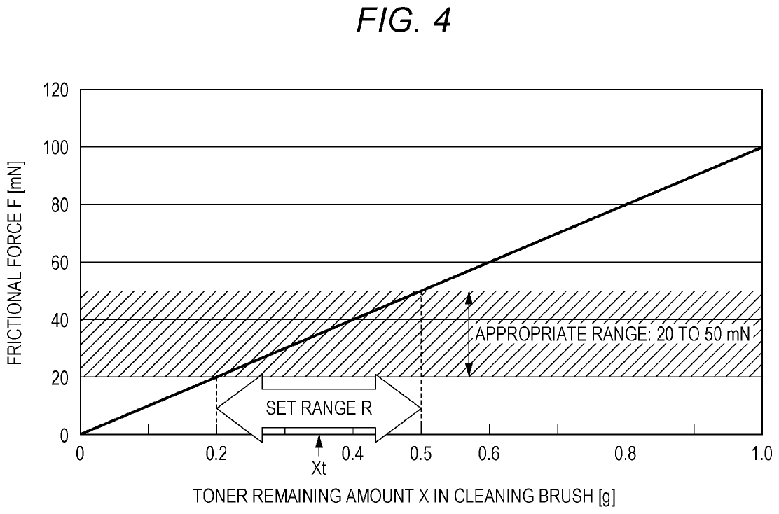

FIG. 3 is a view illustrating a relationship between the frictional force F of the cleaning brush 8 and an a value. FIG. 4 is a view illustrating a relationship between a toner residual amount X and the frictional force F in the cleaning brush 8. The a value in FIG. 3 is a depletion amount of a film thickness of the photoreceptor 4 per 100,000 rotations of the photoreceptor 4.

As illustrated in FIG. 3, the a value is proportional to the frictional force F.

In a case where the frictional force F is smaller than a lower limit of an appropriate range thereof, the protective layer of the photoreceptor 4 is hardly scraped off. That is, the a value is too small. In this case, the lubricant adhered to the surface of the photoreceptor 4 remains unremoved and is gradually deteriorated, and the protective layer is further deteriorated. For this reason, image blur (decrease in sharpness) occurs in the formed image, and a print quality is deteriorated.

In contrast, in a case where the frictional force F is larger than an upper limit of the appropriate range thereof, the protective layer of the photoreceptor 4 is scraped off more than necessary for refreshing. That is, the a value becomes excessive. For this reason, depletion of the protective layer is accelerated, and a life of the photoreceptor 4 is shortened.

In FIG. 3, when a lower limit value of the a value when obtaining a desired image quality is set to 0.02, and an upper limit value of the a value when making the life of the photoreceptor 4 equal to or longer than a predetermined value is set to 0.05, the appropriate range of the frictional force F is 20 to 50 [mN].

As illustrated in FIG. 4, the frictional force F is proportional to the toner residual amount X in the cleaning brush 8.

In order to keep the frictional force F to the value within the range of 20 to 50 [mN] which is the appropriate value, it is sufficient to control the image forming device 1 such that the residual amount X is set to a value within a range of 0.2 to 0.5 [mN] (set range R).

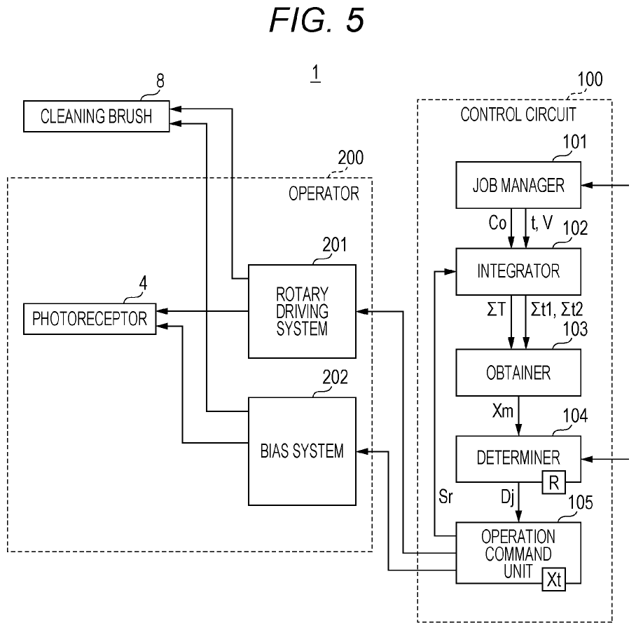

FIG. 5 is a view illustrating a functional configuration of a substantial part of the image forming device 1. Note that, in FIG. 5 and FIGS. 8 and 10 to be described later, the illustrated numbers of elements forming the imaging stations 2 out of the components of the substantial part are one. However, four elements corresponding to the four imaging stations 2y to 2k are actually the components of the substantial part. For example, the photoreceptor 4 in FIG. 5 is illustrated as a representative of the four photoreceptors 4.

In FIG. 5, the image forming device 1 includes an operator 200 which changes the toner residual amount X in the cleaning brush 8 and the control circuit 100 which performs “in-brush toner amount control” on the operator 200.

The in-brush toner amount control is control to allow the operator 200 to operate so that the toner residual amount X in the cleaning brush 8 approaches a set value Xt. The in-brush toner amount control is executed when the toner image corresponding to an image designated by the print job, that is, the toner image to be transferred to the sheet 20 is not formed. The set value Xt related to the in-brush toner amount control is a value within the set range R (0.2 to 0.5) described above, and is set to, for example, a median value (0.35) of the set range R (refer to FIG. 4).

In this embodiment, the toner residual amount X is calculated based on a coverage (printing rate) of the image formed in the print job. The coverage is a ratio of an area (total dot area) of a portion to which the toner is adhered with respect to an area of an image forming area of the sheet 20, which is specified by image data included in the print job.

The operator 200 includes the photoreceptor 4, a rotary driving system 201, and a bias system 202.

The rotary driving system 201 is a system which rotary drives the photoreceptor 4 and the cleaning brush 8. The rotary driving system 201 includes a plurality of or a single motor as a driving source, a transmission mechanism which transmits a driving force of the motor to a drive target, a motor driving circuit which drives the motor and the like.

The bias system 202 is a system which biases the photoreceptor 4 and the cleaning brush 8. The bias system 202 includes a power supply circuit capable of outputting positive and negative bias voltages. The bias system 202 includes the brush potential setting unit 52a and the potential switching unit 52b described above.

The control circuit 100 includes a job manager 101, an integrator 102, an obtainer 103, a determiner 104, an operation command unit 105 and the like. These functions are realized by a hardware configuration of the control circuit 100, by a control program executed by the CPU, or by a combination thereof.

The job manager 101 specifies a coverage Co of all images formed in the print job for each toner color (Y, M, C, and K), and notifies the integrator 102 of the same every time the print job is executed.

The job manager 101 also notifies the integrator 102 of a rotation time t and a rotation speed V of the cleaning brush 8 in the print job as information indicating an operation amount of the cleaning brush 8 every time the print job is executed. The rotation speed V is switched according to setting of a process speed which defines the peripheral speed of the photoreceptor 4 at the time of image formation. In the following, it is assumed that two speeds V1 and V2 (V1>V2) are defined as options of the rotation speed V. However, the number of options may be three or more.

The integrator 102 converts the notified coverage Co for each toner color into a toner amount of the toner image before the primary transfer, and integrates this toner amount for each toner color. Then, a latest integrated value of the toner amount is stored as an integrated toner amount ET.

The integrator 102 integrates the notified rotation time t for each rotation speed V. Then, a latest integrated value of the rotation time t at the speed V1 is stored as an integrated time En, and a latest integrated value of the rotation time t at the speed V2 is stored as an integrated time Et2.

For example, every time the print job is performed, the obtainer 103 obtains an estimated value Xm of the toner residual amount X in the cleaning brush 8 for each toner color. In detail, the obtainer 103 obtains the integrated toner amount ET and the integrated times Et1 and Et2 from the integrator 102 every time they are updated and obtains the estimated value Xm for each toner color by performing an arithmetic operation based on following equation (1) in which the integrated toner amount ET and the integrated times Et1 and Et2 are variables.

Xm=ΣT×A−Σt1×Tu1−Σt2×=Tu2 (1)

In the equation, A represents a constant indicating a transfer residual rate of the primary transfer (value obtained by subtracting a primary transfer rate from 1). Tu1 represents a constant indicating an amount of separated toner per unit time (separated toner amount) separated from the photoreceptor 4 and also separated from the cleaning brush 8 in a case of rotation at the speed V1. Tu2 represents a constant indicating the separated toner amount per unit time in a case of rotation at the speed V2.

That is, the arithmetic operation by equation (1) corresponds to obtaining a value obtained by subtracting the integrated value of the separated toner from the integrated value of the toner remaining on the photoreceptor 4 without being primarily transferred as the residual amount X in the cleaning brush 8.

The determiner 104 determines whether or not the estimated value Xm obtained by the obtainer 103 is a value within the set range R. However, it is possible to design the image forming device 1 such that a case in which the residual amount X is smaller than the lower limit value (0.2) of the set range R scarcely occurs unless a situation of forming only images with extremely small coverage which is close to white paper continues. In a case of such design, the determiner 104 may determine whether or not the estimated value Xm is larger than the upper limit value (0.5) of the set range R.

In any case, the determiner 104 notifies the operation command unit 105 of a determination result Dj. The determination result Dj includes the estimated value Xm used for the determination.

The operation command unit 105 allows the operator 200 to operate such that the residual amount X approaches the set value Xt in a case where the estimated value Xm is determined not to be the value within the set range R or the estimated value Xm is determined to be larger than the upper limit value of the set range R.

For example, in a case where it is determined that the estimated value Xm is larger than the upper limit value of the set range R, a command to rotate the cleaning brush 8 is given to the rotary driving system 201. The rotational direction may be the same as that at the time of image formation. The rotation time may be a time for rotating several times (for example, one to two seconds). It is preferable that the rotation speed V is made higher than the speed V1 which is higher one of the speeds V1 and V2 during image formation. Increasing the rotation speed V increases a centrifugal force to shake off the toner from the brush bristles 81, so that the residual amount X may be reduced to a value within the set range R faster and more efficiently than when the speed is the same as that at the time of image formation.

While the cleaning brush 8 is rotated, the photoreceptor 4 may be stopped, or may be rotated in a manner similar to that at the time of image formation. In a case where the photoreceptor 4 is stopped, sliding between the photoreceptor 4 and the cleaning blade 9 which causes wear of the photoreceptor 4 and the cleaning blade 9 does not occur. In a case where the photoreceptor 4 is rotated, local wear of the photoreceptor 4 by the cleaning brush 8 may be prevented.

While rotating the cleaning brush 8, the operation command unit 105 gives a command to the bias system 202 to bias the cleaning brush 8 to a potential having the same polarity as that of the charging potential of the toner. As a result, an electrostatic repulsive force due to bias is added to the centrifugal force due to rotation, and the separation of the toner from the brush bristles 81 is promoted.

Furthermore, in a case where the photoreceptor 4 is rotated, the photoreceptor 4 may be biased to the potential having the polarity opposite to that of the charging potential of the toner. As a result, an electrostatic action to attract the toner from the brush bristles 81 to the photoreceptor 4 occurs, so that the separation of the toner from the brush bristles 81 is further promoted. The toner moving from the brush bristles 81 to the photoreceptor 4 is removed from the photoreceptor 4 by the cleaning blade 9.

The operation command unit 105 sets a length of a time during which the cleaning brush 8 is rotated at the time of in-brush toner amount control according to a difference between the estimated value Xm included in the determination result Dj and the set value Xt. The larger the difference between the estimated value Xm and the set value Xt, the longer the rotation time.

A relationship between the residual amount X exceeding the upper limit value of the set range R and the rotation time necessary to reduce the same to the set value Xt may be obtained in advance by experiments, for example, and a table indicating the rotation time corresponding to the residual amount X may be stored.

The operation command unit 105 sets the rotation time by a lookup table method referring to this table. When the rotation time is set in this manner, it is possible to approximate the residual amount X to the set value Xt within an error range between the estimated value Xm and the actual residual amount X.

The operation command unit 105 gives an integration reset command Sr to the integrator 102 at the end of the in-brush toner amount control.

When receiving the integration reset command Sr, the integrator 102 resets the integrated toner amount ΣT to a value obtained by multiplying the set value Xt by an inverse number (1/A) of the constant A. That is, the obtainer 103 may calculate the estimated value Xm on the assumption that the residual amount X increases from the set value Xt in subsequent print jobs.

When the integrator 102 receives the integration reset command Sr, this resets both the integrated times Σt1 and Σt2 to 0.

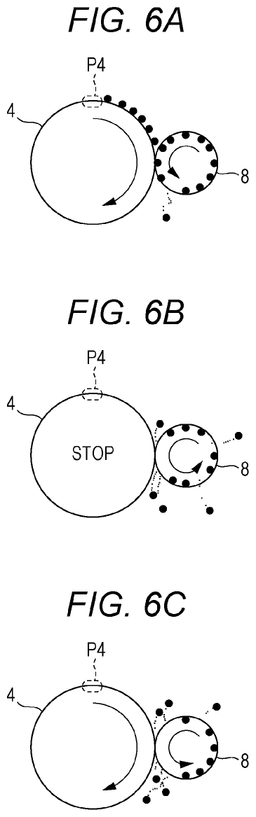

FIGS. 6A to 6C are views schematically illustrating states of the photoreceptor 4 and the cleaning brush 8 at the time of image formation and in-brush toner amount control. In FIGS. 6A to 6C, black circles indicate the toner.

As illustrated in FIG. 6A, at the time of image formation, a transfer residual toner remained without being transferred adheres to a portion between the primary transfer position P4 on the surface of the photoreceptor 4 and the cleaning brush 8.

At least a part of the transfer residual toner moves from the photoreceptor 4 to the cleaning brush 8 and adheres to the cleaning brush 8. Some toner is separated after adhering to the cleaning brush 8, but some toner remains adhering to the cleaning brush 8.

In FIG. 6B, the in-brush toner amount control is performed in which the photoreceptor 4 is stopped and the cleaning brush 8 is rotated. Since the image formation is not performed, the transfer residual toner does not adhere to the photoreceptor 4.

In FIG. 6C, the in-brush toner amount control is performed in which the cleaning brush 8 is rotated and the photoreceptor 4 is also rotated.

If the photoreceptor 4 is rotated, for example, at the same speed as that at the time of image formation and the cleaning brush 8 is rotated at the speed faster than that at the time of image formation, the peripheral speed difference between the photoreceptor 4 and the cleaning brush 8 becomes larger than that at the time of image formation and an impact when the brush bristles 81 abut increases. A synergistic effect of the increase in impact and the increase in centrifugal force due to fast rotation of the cleaning brush 8 promotes the separation of the residual toner.

It is possible to rotate the cleaning brush 8 at the speed faster than that at the time of image formation and also rotate the photoreceptor 4 at the speed faster than that at the time of image formation, thereby making the peripheral speed difference equivalent to or smaller than that at the time of image formation to reduce wear of the photoreceptor 4. In this case also, the separation of the residual toner proceeds faster than that at the time of image formation due to the increase in centrifugal force.

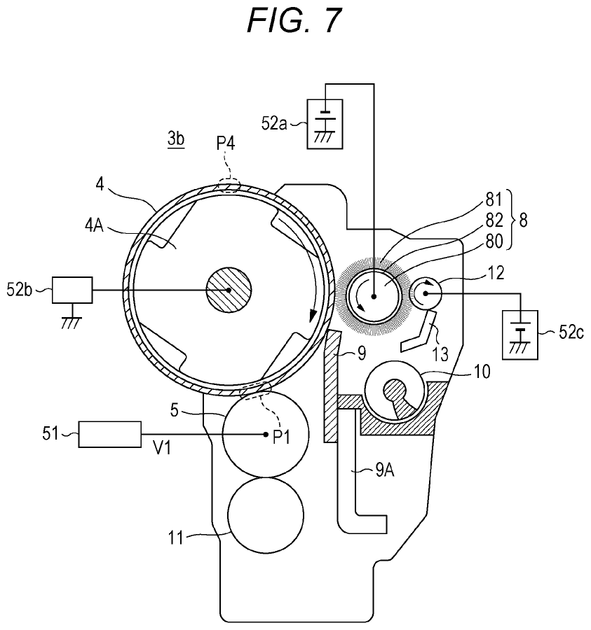

FIG. 7 is a view illustrating a variation of the configuration of the photoreceptor drum unit 3.

A basic configuration of a photoreceptor drum unit 3b illustrated in FIG. 7 is similar to that of the photoreceptor drum unit 3. A difference between the photoreceptor drum unit 3b and the photoreceptor drum unit 3 is that the photoreceptor drum unit 3b includes a flicker 12 and a scraper 13 not included in the photoreceptor drum unit 3.

The flicker 12 is a metallic roller and is arranged in a biting state in which this is pressed against brush bristles 81 of a cleaning brush 8. A rotational direction of the flicker 12 is a with direction in which a moving direction of a peripheral edge is the same direction as that of the cleaning brush 8 at an abutment portion with the brush bristles 81. The flicker 12 is biased to a potential having a polarity opposite to that of a charging potential of toner by a flicker potential setting unit 52c.

At the time of image formation, the flicker 12 and the cleaning brush 8 are rotary driven. Toner adhering to the brush bristles 81 is separated from the brush bristles 81 due to impact by abutment between the brush bristles 81 and the flicker 12 and electrostatic attraction. A part of the separated toner falls, and part adheres to a peripheral surface of the flicker 12.

The scraper 13 is formed of, for example, a metallic plate. The scraper 13 scrapes off the toner adhering to the peripheral surface of the flicker 12.

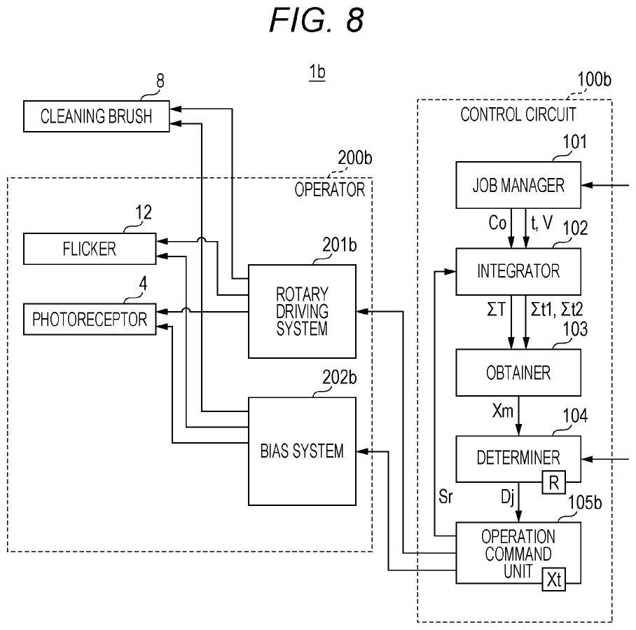

FIG. 8 is a view illustrating a functional configuration of a substantial part of an image forming device 1b. The image forming device 1b forms an image using the photoreceptor drum unit 3b illustrated in FIG. 7 in place of the photoreceptor drum unit 3 in the configuration of the image forming device 1 illustrated in FIG. 1. In the image forming device 1b also, in-brush toner amount control is performed.

The image forming device 1b includes an operator 200b which changes a toner residual amount X in the cleaning brush 8 and a control circuit 100b which performs the in-brush toner amount control on the operator 200b.

The operator 200b includes a photoreceptor 4, the flicker 12, a rotary driving system 201b, and a bias system 202b.

The rotary driving system 201b is a system which rotary drives the photoreceptor 4, the cleaning brush 8, and the flicker 12.

The bias system 202b is a system which biases the photoreceptor 4, the cleaning brush 8, and the flicker 12. The bias system 202b includes a brush potential setting unit 52a, a potential switching unit 52b, and the flicker potential setting unit 52c.

A configuration of the control circuit 100b is similar to the configuration of the control circuit 100 except in including an operation command unit 105b in place of the operation command unit 105 of the control circuit 100 in FIG. 5.

A basic function of the operation command unit 105b is similar to the function of the operation command unit 105 described above. A difference in function between the operation command unit 105b and the operation command unit 105 is that the operation command unit 105b outputs a command related to the flicker 12. Details are as follows.

An obtainer 103 obtains an estimated value Xm for each toner color by performing an arithmetic operation based on equation (1) as described above. However, values of separated toner amounts Tu1 and Tu2 in equation (1) in this case are made values corresponding to the photoreceptor drum unit 3b including the flicker 12.

In a case where it is determined that the estimated value Xm is larger than an upper limit value of a set range R by a determiner 104, the operation command unit 105b gives a command to rotate the flicker 12 to the rotary driving system 201b. A command to rotate the cleaning brush 8 and the flicker 12 or a command to rotate the cleaning brush 8, the photoreceptor 4, and the flicker 12 may also be given.

A rotational direction of the flicker 12 may be the same as that at the time of image formation. The rotation speed may be made faster than that at the time of image formation to promote toner separation from the cleaning brush 8.

While rotating the flicker 12, the operation command unit 105b gives a command to bias the flicker 12 to the potential having the polarity opposite to that of the charging potential of the toner to the bias system 202b. As a result, an electrostatic attraction force is added to an impact force by the abutment, and the toner separation from the brush bristles 81 is promoted.

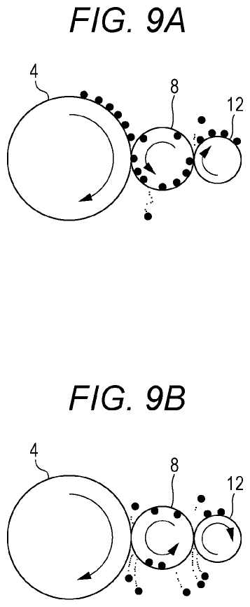

FIGS. 9A and 9B are views schematically illustrating states of the photoreceptor 4, the cleaning brush 8, and the flicker 12 at the time of image formation and in-brush toner amount control. In FIGS. 9A and 9B, black circles represent toner.

As illustrated in FIG. 9A, at the time of image formation, a part of transfer residual toner adhering to a surface of the photoreceptor 4 moves from the photoreceptor 4 to the cleaning brush 8, and a part of the toner remaining on the cleaning brush 8 moves to the flicker 12.

In FIG. 6B, the in-brush toner amount control to rotate the cleaning brush 8, the flicker 12, and the photoreceptor 4 is performed. Since the image formation is not performed, the transfer residual toner does not adhere to the photoreceptor 4.

By making a rotation speed of the cleaning brush 8 faster than that at the time of image formation, separation of the toner from the brush bristles 81 is promoted. By rotating the flicker 12 at a speed at which a peripheral speed difference from the cleaning brush 8 becomes larger than that at the time of image formation, the impact when the brush bristles 81 abut the flicker 12 increases and the toner separation from the brush bristles 81 is promoted.

An aspect of the in-brush toner amount control is not limited to the aspect in which the operators 200 and 200b are allowed to operate so as to reduce the residual amount X and there also is the aspect of allowing the image forming device to operate so as to increase the residual amount X in a case where the residual amount X is extremely small.

As a method of intentionally increasing the toner residual amount X in the cleaning brush 8, there may be a method of forming a toner image only for increasing the residual amount X and supplying the same to the cleaning brush 8 without performing primary transfer.

Next, an example of the configuration of the image forming device which performs the in-brush toner amount control by this method is described.

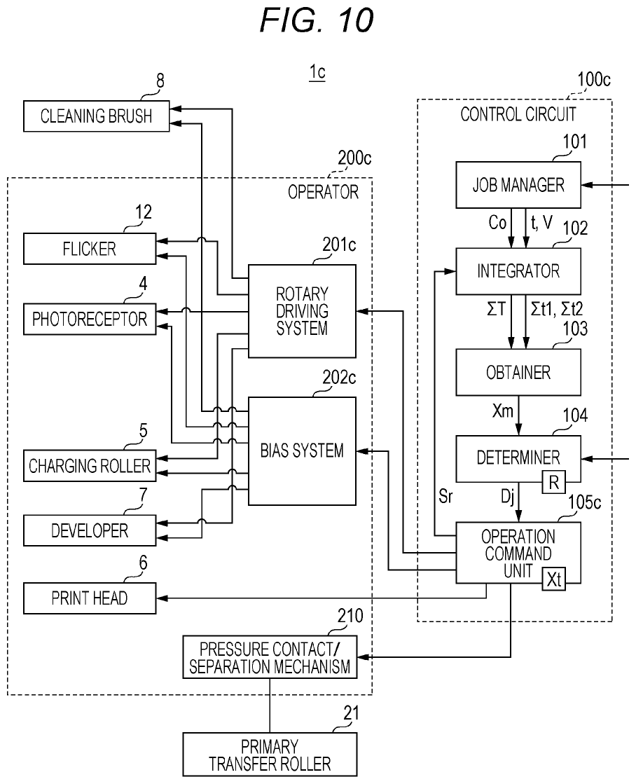

FIG. 10 is a view illustrating a functional configuration of a substantial part of an image forming device 1c. The image forming device 1c forms an image using a photoreceptor drum unit 3b as in the image forming device 1b illustrated in FIG. 8.

The image forming device 1c includes an operator 200c which changes a toner residual amount X in a cleaning brush 8, and a control circuit 100c which performs in-brush toner amount control on the operator 200c.

The operator 200c includes a photoreceptor 4, a charging roller 5, a developer 7, a print head 6, a pressure contact/separation mechanism 210, a flicker 12, a rotary driving system 201c, and a bias system 202c. The operator 200c does not include a primary transfer roller 21.

The rotary driving system 201c is a system which rotary drives the photoreceptor 4, the cleaning brush 8, and the flicker 12.

The bias system 202c is a system which biases the photoreceptor 4, the charging roller 5, the developer 7, the cleaning brush 8, and the flicker 12. The bias system 202c includes a brush potential setting unit 52a, a potential switching unit 52b, a flicker potential setting unit 52c, and a high-voltage power supply circuit 51 for charging.

A configuration of the control circuit 100c is similar to the configuration of the control circuit 100 in FIG. 5 and that of the control circuit 100b in FIG. 8 except in including an operation command unit 105c in place of the operation command unit 105b of the control circuit 100b in FIG. 8.

The operation command unit 105c has a function of issuing a command for increasing the residual amount X in addition to the function of the operation command unit 105b described above. Details are as follows.

An obtainer 103 obtains an estimated value Xm for each toner color by performing an arithmetic operation based on equation (1) as in the example in FIG. 8.

The determiner 104 determines whether or not the estimated value Xm obtained by the obtainer 103 is a value within the set range R. That is, it is determined whether or not the estimated value Xm is larger than an upper limit value (0.5) of the set range R, and whether or not the estimated value Xm is smaller than a lower limit value (0.2) of the set range R.

Then, the determiner 104 notifies the operation command unit 105c of a determination result Dj. The determination result Dj includes the estimated value Xm used for the determination.

In a case where it is determined that the estimated value Xm is larger than the upper limit value of the set range R by the determiner 104, the operation command unit 105c gives a command to rotate the cleaning brush 8, the photoreceptor 4, and the flicker 12, for example, to the rotary driving system 201c. At the same time, this gives a command to bias the cleaning brush 8, the photoreceptor 4, and the flicker 12 to a potential of a polarity effective for separation of toner from the cleaning brush 8 to the bias system 202c.

In contrast, in a case where the determiner 104 determines that the estimated value Xm is smaller than the lower limit value of the set range R, the operation command unit 105c gives a command to form a toner image under the same process condition as that at the time of image formation, for example, to the rotary driving system 201c and the bias system 202c.

In addition, the operation command unit 105c gives a command to the print head 6 to form a latent image of a pattern prepared in advance. As this pattern, a pattern having a uniform dot density in a main-scanning direction is preferable. For example, a set pattern may be a band-shaped fill pattern which is long in the main-scanning direction, a solid pattern an entire formable region of which is filled, or a halftone dot pattern.

A plurality of patterns having different coverages Co may also be prepared so that a toner amount to be supplied to the cleaning brush 8 may be adjusted. The operation command unit 105c selects a pattern in which a value obtained by converting the coverage Co into the toner amount is the closest to a difference between the set value Xt and the estimated value Xm out of a plurality of patterns and controls the print head 6 to form a latent image of the selected pattern.

Furthermore, the operation command unit 105c gives a command to arrange the primary transfer roller 21 in a position in which an intermediate transfer belt 22 is separated from the photoreceptor 4 until the toner image passes through the primary transfer position P4 to the pressure contact/separation mechanism 210.

By such control, the toner image is formed on the photoreceptor 4 and is carried to an abutment portion between the cleaning brush 8 and the photoreceptor 4 without being primarily transferred, and is scraped off by the cleaning brush 8. The scraped toner remains on the cleaning brush 8, and the toner residual amount X in the cleaning brush 8 increases to the set value Xt or a value close thereto.

The operation command unit 105 gives an integration reset command Sr to the integrator 102 at the end of the in-brush toner amount control.

When receiving the integration reset command Sr, the integrator 102 resets an integrated toner amount ΣT to a value obtained by multiplying the set value Xt by an inverse number of a constant A as described above, and resets both integrated times En and Σt2 to 0.

According to the embodiment described above, it is possible to reduce excess or deficiency of the frictional force of the cleaning brush 8 with respect to the photoreceptor 4 depending on the toner residual amount X in the cleaning brush 8. As a result, it is possible to prevent a decrease in the life of the photoreceptor 4 due to an excessive frictional force, and a decrease in image quality due to an extremely small frictional force. It is also possible to suppress occurrence of brush creep in which a fiber shape of the brush bristles 81 remains bent.

In the embodiment described above, the in-brush toner amount control may be selectively executed for the imaging station 2 in which the residual amount X is excessive or insufficient out of the four imaging stations 2y to 2k.

In the above-described embodiment, it is described that the residual amount X is estimated based on the coverage specified by the image data of the image to be printed; however, the residual amount X may also be measured using a sensor. For example, a degree of change in color of the brush bristles 81 which approaches a toner color from a color of the fiber itself as the toner adheres is detected as the residual amount X. Alternatively, the brush bristles 81 may be photographed and the amount of toner in the fiber may be analyzed by image processing. In this case, it is preferable to determine the color of the fiber so that the fiber and the toner may be easily distinguished. For example, for the brush bristles 81 of the cleaning brush 8 to which black toner adheres, the color of the fiber is set to white or another light color.

Hardness of the brush bristles 81 may be measured as the toner residual amount X. For example, a small-sized force sensor is arranged in a position where the brush bristles 81 abut, and a pressing force applied to the force sensor when the brush bristles 81 abut is measured. The pressing force is larger as the brush bristles 81 are harder, that is, as the residual amount X is larger. Therefore, it is possible to determine whether the residual amount X is excessive or insufficient based on the measured value of the pressing force.

In the embodiment described above, in a case of performing the in-brush toner amount control to rotate the cleaning brush 8 while stopping the photoreceptor 4, the cleaning brush 8 may be rotated in the same direction as that at the time of image formation or in the opposite direction. However, it is preferable to rotate in a direction in which more toner pops out in a direction toward the conveying screw 10.

In the above-described embodiment, it is described that the rotation time of the cleaning brush 8 based on the in-brush toner amount control is set to a time until the residual amount X reaches the set value Xt; however, the present invention is not limited to this. The rotation time may be set to a constant time. In this case, a value obtained by subtracting a product of the rotation time and the separated toner amount per unit time from the residual amount X at the start of the control is obtained as the residual amount X at the end of the control, and this may be made an initial value when resetting the integrated toner amount ΣT by the integrator 102.

In the embodiment described above, control to rotate the cleaning brush 8 at the time other than image formation time may be performed in addition to the in-brush toner amount control. For example, in a high-temperature and high-humidity environment, the lubricant adhering to the photoreceptor 4 is likely to absorb moisture to be fastened, so that an image quality is likely to be deteriorated. Therefore, in a case where formation of an image with large coverage is continued in a high-temperature and high-humidity environment and it is estimated that an adhering amount of the lubricant is large, the cleaning brush 8 is preferably rotated to remove the lubricant adhering to the photoreceptor 4.

In the embodiment described above, it is possible to change the lower limit value or the upper limit value of the set range R such that a desired effect may be obtained by the in-brush toner amount control according to the printed number of the print job or a measured value of an environment condition (for example, temperature and humidity).

For example, it is considered that an increase in the toner residual amount X in the cleaning brush 8 is more remarkable as the printed number increases. Therefore, in a case where the printed number is larger than a threshold, the set range R is changed from 0.2 to 0.5 to 0.2 to 0.4, for example, thereby facilitating execution of the in-brush toner amount control.

In a case where the temperature is higher than a threshold, the set range R is changed to, for example, 0.2 to 0.4 in order to suppress occurrence of image blur, so that the in-brush toner amount control is easily executed.

In addition, the configuration of an entire or a part of the image forming devices 1, 1b, and 1c, materials, dimensions, processing contents or timing, and a structure of the brush bristles 81 in the cleaning brush 8 may be appropriately changed in accordance with the spirit of the present invention.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming device comprising:
a photoreceptor that forms a toner image;
a brush that abuts the photoreceptor to clean a surface of the photoreceptor;
an operator that changes a toner residual amount in the brush; and
a hardware processor that performs in-blush toner amount control to allow the operator to operate such that the residual amount approaches a set value when a toner image for printing according to a print job is not formed on the photoreceptor as the toner image.

2. The image forming device according to claim 1,
wherein the hardware processor
obtains an estimated value of the residual amount,
determines whether or not the obtained estimated value is a value within a set range, and
performs the in-brush toner amount control in a case where the estimated value is determined not to be the value within the set range.

3. The image forming device according to claim 1,
wherein the hardware processor
obtains an estimated value of the residual amount,
determines whether or not the obtained estimated value is larger than an upper limit value of a set range including the set value, and
performs the in-brush toner amount control in a case where the estimated value is determined to be larger than the upper limit value.

4. The image forming device according to claim 3,
wherein the hardware processor performs an arithmetic operation based on an arithmetic equation in which an integrated value of a toner amount of the toner image for printing according to each of a plurality of jobs being the print jobs and an operation amount of the brush are variables to obtain the estimated value.

5. The image forming device according to claim 3,
wherein the brush is a roll brush,
the operator includes a rotary driving device that rotary drives the brush, and
the hardware processor allows the rotary driving device to rotary drive the brush over a set time as the in-brush toner amount control.

6. The image forming device according to claim 5,
wherein a rotation speed of the brush by the in-brush toner amount control is higher than a rotation speed of the brush when the toner image for printing is formed.

7. The image forming device according to claim 5,
wherein the rotary driving device is a device that rotary drives the brush and the photoreceptor, and
the in-brush toner amount control includes control to rotate the photoreceptor.

8. The image forming device according to claim 5, further comprising:
a roller-type flicker that abuts the brush,
wherein the rotary driving device is a device that rotary drives the brush, the photoreceptor, and the flicker, and
the in-brush toner amount control includes control to rotate the flicker.

9. The image forming device according to claim 5,
wherein the operator includes a bias circuit for biasing the brush, and
the in-brush toner amount control includes control for allowing the bias circuit to bias the brush to a potential having a same polarity as a polarity of the toner.

10. The image forming device according to claim 9,
wherein the bias circuit is a circuit that biases the brush and the flicker, and
the in-brush toner amount control includes control for allowing the bias circuit to bias the flicker to a potential having a polarity opposite to the polarity of the toner.

11. The image forming device according to claim 1,
wherein the hardware processor
obtains an estimated value of the residual amount,
determines whether the obtained estimated value is smaller than a lower limit value of a set range including the set value, and
performs the in-brush toner amount control in a case where the estimated value is determined to be smaller than the lower limit value.
